(19) United States
(12) Patent Application Publication
(10) Pub. No.: US 2014/0260395 A1
(43) Pub. Date: Sep. 18, 2014

(54) MERCHANDISER WITH LOUVER RETAINER

(71) Applicant: HUSSMANN CORPORATION, Bridgeton, MO (US)

(72) Inventor: Michael A. Grill, Overland, MO (US)

(73) Assignee: HUSSMANN CORPORATION, Bridgeton, MO (US)

(21) Appl. No.: 13/795,377

(22) Filed: Mar. 12, 2013

(51) Int. Cl. A47F 3/04; B23P 11/02

(52) U.S. Cl. CPC A47F 3/0482; B23P 11/02
USPC 62/255; 29/450

(57) ABSTRACT

A refrigerated merchandiser including a case that defines a product display area and that has a base defining an air inlet disposed adjacent the product display area. The merchandiser also includes a canopy that has an air outlet located adjacent the product display area, an air passageway fluidly connecting the air inlet with the air outlet, and a louver coupled to the canopy and positioned across the air outlet to direct an airflow into the product display area. The merchandiser also includes a louver retainer that is coupled to the canopy to support the louver. The louver retainer defines a cutout through which a portion of the louver is exposed to facilitate at least one of installation and removal of the louver from the canopy.

### BACKGROUND

The present invention relates to a refrigerated merchandiser, and more particularly to a refrigerated merchandiser including a canopy louver retainer.

In conventional practice, supermarkets and convenience stores are equipped with refrigerated merchandisers that have open display portions for presenting fresh food or beverages in a product display area to customers while maintaining the fresh food and beverages (i.e., food product) in a refrigerated environment. Typically, refrigerated merchandisers include a canopy disposed substantially above the product display area through which air is directed to condition the product display area. Typically, the canopy has an air outlet located adjacent the product display area and a louver positioned over the air outlet to direct an air curtain through or adjacent the product display area. In existing merchandisers, installing and removing the louver can be time-consuming and cumbersome, and frequently requires the use of tools and/or fasteners.

### SUMMARY

In one construction, the invention provides a refrigerated merchandiser including a case that defines a product display area and that has a base defining an air inlet disposed adjacent the product display area. The merchandiser also includes a canopy that has an air outlet located adjacent the product display area, an air passageway fluidly connecting the air inlet with the air outlet, and a louver coupled to the canopy and positioned across the air outlet to direct an airflow into the product display area. The merchandiser also includes a louver retainer that is coupled to the canopy to support the louver. The louver retainer defines a cutout through which a portion of the louver is exposed to facilitate at least one of installation and removal of the louver from the canopy.

In another construction, the invention provides a merchandiser including a case defining a product display area and an air passageway that has an air outlet in communication with the product display area to condition the product display area. The merchandiser also includes a louver coupled to the case over the outlet to direct the airflow into the product display area, and a louver retainer that is coupled to the case adjacent the outlet and that has a support surface to support the louver. The louver retainer defines a cutout exposing a portion of the louver to permit attachment and removal of the louver in response to a force applied to the louver through the cutout.

In another construction, the invention provides a method of assembling a louver in a merchandiser having an air outlet. The method includes engaging a first longitudinal edge of the louver with a first bracket coupled adjacent a first side of the air outlet, aligning a second longitudinal edge of the louver with a second bracket spaced from the first bracket adjacent a second side of the air outlet, and applying a force to the second longitudinal edge. The method also includes at least one of compressing and bending the louver in response to the force applied to the second longitudinal edge, and engaging the louver with the second bracket.

Other aspects of the invention will become apparent by consideration of the detailed description and accompanying drawings.

### BRIEF DESCRIPTION OF THE DRAWINGS

FIG. 1 is a section view of a refrigerated merchandiser embodying the present invention,

FIG. 2 is a section view of a portion of the merchandiser taken along line 2-2 of FIG. 1 and illustrating a canopy, a louver retainer, and a louver supported by the louver retainer.

FIG. 3 is a perspective view of a portion of the canopy, the louver retainer, and the louver.

FIG. 4 is a side view of a portion of the louver retainer.

FIG. 5 is a section view of the louver retainer illustrated in FIG. 4 taken along line 5-5.

FIG. 6 is an enlarged perspective view of a portion of the canopy illustrating the louver retainer and the louver.

FIG. 7 is an enlarged perspective view of the canopy similar to FIG. 6 and illustrating installation/removal of the louver relative to the louver retainer.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

FIG. 1 shows one construction of a refrigerated merchandiser 10 that may be located in a supermarket or a convenience store (not shown) fbr presenting fresh food, beverages, and other food product (not shown) to consumers. The refrigerated merchandiser 10 includes a case 15 that has a base 20, a rear wall 25, and a canopy 30. At least a portion of a refrigeration system (not shown) can be located within the case 15 to refrigerate the food product. The area partially enclosed by the base 20, the rear wall 25, and the canopy 30 defines a product display area 35 that stores the food product in the case 15 and that is accessible by a customer through an opening 40 adjacent the front of the case 15. In some constructions, the merchandiser 10 can include doors (not shown) that enclose and provide access to the product display area 35.

The base 20 is disposed substantially below the product display area 35 and can be supported by a floor or support surface (not shown) of the supermarket. The base 20 defines a lower portion of the product display area 35 that can support a portion of the food product in the case 15. The base 20 further defines an air inlet 45 disposed adjacent the product display area 35 to receive surrounding air. The merchandiser 10 also includes shelves 50 disposed within the product display area 35 to support food product. Each shelf 50 is attached to the rear wall 25 at one end, and extends outward from the rear wall 25 toward the front of the case 15.

Referring to FIGS. 1-3, the canopy 30 is disposed substantially above the product display area 35 and supports a light assembly 55 adjacent the outward end of the canopy 30 to illuminate the product display area 35. The canopy 30 has an air outlet 60 that is located above the product display area 35 and that is fluidly connected to the air inlet 45 by an air passageway 65. An evaporator (not shown) is disposed in the air passageway 65 to refrigerate the airflow. As is known in the art, the evaporator is configured to receive a saturated refrigerant that has passed through an expansion valve. The saturated refrigerant is evaporated as it passes through the evaporator as a result of absorbing heat from the airflow passing over the evaporator. The absorption of heat by the refrigerant allows the temperature of the airflow to decrease as it passes over the evaporator. The heated or gaseous refrigerant then exits the evaporator and is pumped back to one or more compressors (not shown) for re-processing into the refrigeration system. In other constructions, the evaporator could be replaced with another heat exchanger (e.g., secondary heat exchanger, etc.) that allows the absorption of heat from the circulated air into a refrigerant or other heat-transfer fluid within the heat exchanger. Cold exit air from the evaporator is circulated to the air outlet 60 in the canopy 30 from which a refrigerated primary air curtain is formed across the open front of the product display area 35 and returned through a return air duct (not shown) back to the base 20 for recirculation.

The air outlet 60 is defined by internal, spaced apart walls 70, 75. In the illustrated construction, the air outlet 60 includes a primary outlet 80 that is disposed adjacent the product display area 35, and a secondary outlet 85 that is located outward from the primary outlet 80 adjacent an end of the canopy 30. The airflow 90 that is discharged from the primary outlet 80 is refrigerated and defines a primary air curtain. The illustrated airflow 95 that is discharged from the secondary outlet 85 is not refrigerated and defines a secondary air curtain to limit entrainment of warm, ambient air into the refrigerated primary air curtain. Warmer ambient conditions surrounding the refrigerated merchandiser 10 increase cooling requirements and can undesirably increase the temperature of the food product in the product display area 35. In other constructions, the air outlet 60 may include a single outlet that defines a single air curtain.

With reference to FIGS. 2 and 3, the canopy 30 includes a first bracket 100 coupled to a forward portion of the canopy 30 and a second bracket 105 spaced from the first bracket 100 to support an opposite longitudinal edge of a louver 110. The illustrated first bracket 100 is coupled to the wall 70 adjacent the light assembly 55 (behind the light assembly 55), and the illustrated second bracket 105 is coupled to the wall 75. The first and second brackets 100, 105 cooperatively define a louver retainer 115 that supports the louver 110. With reference to FIGS. 2 and 6, the illustrated first bracket 100 is bent (e.g., the bracket 100 is defined by an “L”-shape when viewed from the side—see FIG. 2) and is defined by a first attachment portion 120 and a first retainer portion 125. The first attachment portion can be attached to the wall 70 by a suitable attachment mechanism (e.g., fasteners, adhesive, etc.). The first retainer portion 125 extends rearward from the first attachment portion 120 at a 90° angle and defines a first support surface 130 for the louver 110.

As shown in FIG. 2-4, the second bracket 105 is bent (e.g., the bracket is defined by an “L”-shape when viewed from the side) and is defined by a second attachment portion 135 and a second retainer portion 140. The second attachment portion 135 depends downward from adjacent an edge of the wall 75. The second retainer portion 140 extends forward from the second attachment portion 135 at approximately a 90° angle and defines a second support surface 145 for the louver 110. Although the illustrated second bracket 105 covers a substantial portion of the wall 75, the second bracket 105 can be much shorter than the depth of the wall 75. Referring to FIG. 4, the illustrated second bracket 105 defines a hook-shaped rearward end 150 that can be used to support structure near the back of the case 15. In some constructions, the rearward end 150 can be omitted.

The second bracket 105 has a plurality of cutouts 160 (e.g., recesses or slots) through which a portion of the longitudinal edge of the louver 110 is exposed to facilitate installation and removal of the louver 110 from the canopy 30. In the illustrated construction, the second attachment portion 135 and second retainer portion 140 cooperatively define the cutouts 160 to expose a side surface and a lower surface of the louver 110. Referring to FIGS. 5-7, the illustrated cutout 160 is dimensioned and sized such that a user's finger F can press on a side of the louver 110. As illustrated in FIGS. 5-7, the cutout 160 is generally rectangular in a cross-section. In other constructions, the cutout 160 may have a different shape (e.g., “U”-shape, “V”-shape, semi-circular in cross-section, or another polygonal or curved shape). Although the illustrated bracket 105 has two cutouts 160 spaced apart from each other across the second bracket 105, one or more than two cutouts 160 can be provided, if desired. In some constructions, the first bracket 100 can include one or more cutouts (not shown) to further assist with installation and removal of the louver 110.

Referring to FIGS. 2-4, the illustrated louver retainer 115 includes a ramp 170 extending generally downward from the support surface 145 at an angle θ (e.g., between approximately 130° and 150°) relative to the rearward support surface 145 to guide the louver 110 onto the support surface 145, as described in detail below. Although not shown, a ramp can be provided on the first bracket 100.

The louver 110 is supported by the louver retainer 115 and positioned across the air outlet 60 to guide the primary and secondary airflows 90, 95 into the product display area 35. As illustrated in FIGS. 2, 3, 6, and 7, the louver 110 can be formed of longitudinally arranged plastic straw-like elements 175 of a predetermined length that are adhered to each other to form a generally rectangular elongated panel that is removably coupled to the canopy 30. In other constructions, the louver 110 may be formed in other ways (e.g., the elements 175 may have a rectangular form, a honeycomb structure, etc.). With reference to FIGS. 3 and 7, the louver 110 is flexible such that the louver 110 can bend or bow longitudinally about an axis 180 (e.g., extending along a longitudinal center of the louver 110) in response to a force or pressure applied to the edge of the louver 110 (e.g., by a user's finger F to facilitate installation and removal of the louver 110 relative to the canopy 30. Although FIGS. 2 and 3 illustrate the louver retainer 115 and louver 110 as being coupled to the canopy 30 of an upright merchandiser 10, the louver and the louver retainer 115 can be used in other styles of merchandisers.

With reference to FIGS. 2, 3, 6, and 7, a user installs the louver 110 over the outlet 60 by placing the front edge of the louver 110 on the edge of the first retainer portion 125. The edge of the first retainer portion 125 acts as a fulcrum as the rear side of the louver 110 is lifted or raised upward toward the second bracket 105. With the rear side of the louver 110 positioned adjacent and below the second bracket 105, the user then presses on the rear edge of the louver 110 so that the elements 175 compress slightly. In some circumstances, the louver 110 also bends about the longitudinal axis 180. With the louver 110 slightly compressed and/or bent about the axis 180, the user can raise the louver 110 into alignment with the ramp 170 and into sliding engagement with the support surface 145 via one or more of the cutouts 160. That is, each cutout 160 allows the user's finger F to remain engaged with the rear edge of the louver 110 to hold the louver 110 in the compressed and/or bent orientation while the louver 110 is raised into position on the second bracket 105.

The user can release the rear edge of the louver 110 after the louver 110 is engaged with the ramp 170 so that the louver 110 re-expands and/or straightens out and is fully supported by the support surface 145 and positioned adjacent or in engagement with the second attachment portion 135. Optionally, the user can hold the louver 110 with their finger F via the cutout(s) 160 as the louver 110 returns to its static size within the louver retainer 115. The illustrated louver 110 has a static position width that is approximately the same as the horizontal distance between the first and second attachment portions 120, 135. In other constructions, the width of the louver 110 can be shorter than the distance between the first and second attachment portions 120, 135.

To remove the louver 110, the user essentially reverses the installation process described above. In particular, the user presses on the rear edge of the louver 110 through one or more of the cutouts to compress and/or bend the louver 110 so that the louver moves away from the second attachment portion 135 and out of engagement with the second bracket 105. The louver 110 is angled downward via the user's finger F using the edge of the first retainer portion 125 as a fulcrum after the rear edge of the louver 110 is pushed and/or bent to a position that is forward of the ramp 170. When the rear side of the louver 110 clears the second bracket 105 (i.e. rear side of the louver 110 is disposed below the ramp 170) the louver 110 can be removed from the first bracket 100 by sliding the louver 110 generally rearward and downward. In some constructions, the pressure applied to the louver 110 by the user's finger F will decrease slightly after the louver 110 is disposed below the second bracket 105.

After the louver 110 is removed from the first and second brackets 100, 105, the louver 110 can be cleaned and replaced in the louver retainer 115, or another louver can be installed on the canopy 30. Accordingly, the louver 110 can be installed on the canopy 30 and removed for cleaning or service without tools or fasteners.

Various features and advantages of the invention are set forth in the following claims.

1. A refrigerated merchandiser comprising:
a case defining a product display area and including a base defining an air inlet disposed adjacent the product display area;
a canopy having an air outlet located adjacent the product display area;
an air passageway fluidly connecting the air inlet with the air outlet;
a louver coupled to the canopy and positioned across the air outlet to direct an airflow into the product display area;
a louver retainer coupled to the canopy to support the louver, the louver retainer defining a cutout through which a side of the louver is exposed to facilitate at least one of installation and removal of the louver from the canopy.

2. The refrigerated merchandiser of claim 1 wherein the louver retainer has a first bracket coupled to a forward portion of the canopy to support a longitudinal edge of the louver, and a second bracket spaced from the first bracket to support an opposite longitudinal edge of the louver.

3. The refrigerated merchandiser of claim 2, wherein one of the first bracket and the second bracket defines the cutout.

4. The refrigerated merchandiser of claim 2, wherein the louver retainer further includes a ramp extending at a non-zero angle from at least one of the first and second brackets to facilitate installation and removal of the louver relative to the canopy.

5. The refrigerated merchandiser of claim 1, wherein the louver retainer includes an L-shaped bracket having a first portion and a second portion disposed at approximately a 90° angle relative to the first portion, and wherein the cutout is defined in the first portion and the second portion.

6. The refrigerated merchandiser of claim 1, wherein the cutout is dimensioned and sized to accommodate a user's finger.

7. The refrigerated merchandiser of claim 6, wherein the louver defines a longitudinal axis, and wherein the louver is bendable about the longitudinal axis in response to pressure by the user's finger.

8. The refrigerated merchandiser of claim 1, wherein the cutout has one of a rectangular shape, a U-shape, and a semi-circular shape.

9. A merchandiser comprising:
a case defining a product display area and an air passageway having an air outlet in communication with the product display area to condition the product display area;
a louver coupled to the case over the outlet to direct the airflow into the product display area; and
a louver retainer coupled to the case adjacent the outlet and having a support surface to support the louver, the louver retainer defining a cutout exposing a portion of the louver to permit attachment and removal of the louver in response to a force applied to the louver through the cutout.

10. The merchandiser of claim 9, wherein the cutout exposes an edge of the louver.

11. The merchandiser of claim 10, wherein the louver is at least one of compressible and bendable about a longitudinal axis in response to the force applied to the edge of the louver.

12. The merchandiser of claim 11, further comprising a canopy defining the air outlet and disposed above the product display area.

13. The merchandiser of claim 12, wherein the louver retainer has a first bracket coupled to the canopy to support a first longitudinal edge of the louver, and a second bracket spaced rearward from the first bracket to support an opposite longitudinal edge of the louver, and wherein the second bracket defines the cutout.

14. The merchandiser of claim 13, wherein the second bracket is L-shaped and has a first portion and a second portion disposed at approximately a 90° angle relative to the first portion, and wherein the cutout is defined in the first portion and the second portion.

15. The merchandiser of claim 9, wherein the louver retainer further includes a ramp extending at a non-zero angle from the support surface.

16. The merchandiser of claim 9, wherein the louver retainer includes a plurality of cutouts.

17. A method of assembling a louver in a merchandiser having an air outlet, the method comprising:
engaging a first longitudinal edge of the louver with a first bracket coupled adjacent a first side of the air outlet;
aligning a second longitudinal edge of the louver with a second bracket spaced from the first bracket adjacent a second side of the air outlet;
applying a force to the second longitudinal edge;
at least one of compressing and bending the louver in response to the force applied to the second longitudinal edge; and
engaging the louver with the second bracket.

18. The method of claim 17, further comprising applying the force to the second longitudinal edge through a cutout in the second bracket.

19. The method of claim 18, wherein the aligning step includes placing the second longitudinal edge adjacent and below the second bracket, and wherein the engaging step includes raising the second longitudinal edge into alignment with a support surface defined by the second bracket.

20. The method of claim 19, removing the force from the second longitudinal edge after the louver is aligned with the support surface.
